(19) United States
(12) Patent Application Publication
(10) Pub. No.: US 2006/0159425 A1
(43) Pub. Date: Jul. 20, 2006

(54) Hybrid video device capable of copying part of original title and method for copying part of original title in the same

(75) Inventor: Sang Cheol Choi, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/253,588

(22) Filed: Oct. 20, 2005

(30) Foreign Application Priority Data
Jan. 17, 2005 (KR) 10-2005-0004328

(51) Int. Cl. H04N 5/91

(52) U.S. Cl. 386/94

(57) ABSTRACT

A hybrid video device that is capable of selectively copying portions of an original title desired by the user, and a method for copying specific portions of an original title in the same are provided. The hybrid video device includes a first video recording unit, a second video recording unit which records video independently of the first video recording unit, and a copy management unit. The copy management unit performs copy management such that portions, selected by the user, of an original title stored in one of the two video recording units are copied to the other video recording unit.

### CROSS-REFERENCE TO RELATED APPLICATIONS

This application claims the benefit under 35 U.S.C. §119(a) of Korean Patent Application No. 10-2005-0004328, filed in the Korean Intellectual Property Office on Jan. 17, 2005, the entire disclosure of which is incorporated herein by reference.

### BACKGROUND OF THE INVENTION

1. Field of the Invention

The present invention relates to a hybrid video device that is capable of copying part of an original title, and a method for copying part of an original title in the same. More particularly, the present invention relates to a hybrid video device that is capable of selectively copying specific portions, desired by the user, of an original title to be copied, and a method for copying specific portions of an original title in the same.

2. Description of the Related Art

As known to those skilled in the art, a video system integrating two or more video devices is called a “hybrid video device”. Some examples of such conventional hybrid video devices are a DVDP/VCR combo combining a DVD player (DVDP) and a Video Cassette Recorder (VCR), and an HDD/DVD recorder combining a Hard Disk Drive (HDD) and a Digital Versatile Disc (DVD).

The conventional HDD/DVD recorder includes an HDD and a DVD drive built in a cabinet, and stores input video in the HDD or to a DVD disc (DVD-R/RW/RAM), or reproduces the stored video. As needed, the conventional HDD/DVD recorder copies video stored in the HDD to a DVD disc, or copies video stored on a DVD disc to the HDD.

Copying, which is termed “dubbing”, is classified into categories including high-speed copying and transrating copying. In such high-speed copying, files are copied at high speed. Transrating copying is performed by changing the bit rate or switching the DVD recording format to single speed. The DVD recording formats, which are switched in the transrating copying, are divided into V and VR formats. If a DVD-R disc is finalized after video is recorded on the disc in the V format, its format becomes a DVD video format. The VR format is noted as improving upon the editing features of the V format.

However, since there is no feature for selectively copying certain portions of an original title, the conventional HDD/DVD recorder must inevitably copy the entirety of the original title, even if the user desires to copy only certain portions of the original title.

One method to overcome this problem is to produce a playlist by collecting portions of titles, which the user desires to copy, and copy the produced playlist. However, this method causes inconvenience to the user.

Accordingly, a need exists for a system and method for selectively copying all or part of an original title with minimal inconvenience to the user.

### SUMMARY OF THE INVENTION

Therefore, it is an aspect of the present invention to substantially solve the above and other problems, and provide a hybrid video device that is capable of selectively copying all or part of an original title, and a method for copying part of an original title in the same.

Additional aspects and advantages of the invention will be set forth in part in the description which follows and, in part, will be obvious from the description, or may be learned by the practice of the present invention.

In accordance with the present invention, the above and other aspects can be achieved by providing a hybrid video device comprising a first video recording unit, a second video recording unit for recording video independently of the first video recording unit, and a copy management unit for performing copy management such that a part, selected by a user, of an original title stored in one of the first and second video recording units is copied to the other video recording unit.

### BRIEF DESCRIPTION OF THE DRAWINGS

These and other aspects and advantages of the present invention will become apparent and more readily appreciated from the following description, taken in conjunction with the accompanying drawings, of which:

FIG. 1 is a block diagram of an HDD/DVD recorder according to an embodiment of the present invention;

FIG. 2 is a flow chart of a method for copying portions, desired by the user, of an original title through a real-time set copy operation according to an embodiment of the present invention;

FIG. 3 is a flow chart of a method for copying portions, desired by the user, of an original title through a preset copy operation according to an embodiment of the present invention;

FIG. 4 is a diagram illustrating a copy menu displayed on a TV screen when copying is performed through the HDD/DVD recorder of FIG. 1 according to an embodiment of the present invention;

FIG. 5 is a diagram illustrating a TV screen displayed when the HDD/DVD recorder of FIG. 1 performs a real-time set copy operation according to an embodiment of the present invention; and

FIG. 6 is a diagram illustrating a TV screen displayed when the HDD/DVD recorder of FIG. 1 performs a preset copy operation according to an embodiment of the present invention.

Throughout the drawings, like reference numerals will be understood to refer to like parts, components and structures.

### DETAILED DESCRIPTION OF THE EXEMPLARY EMBODIMENTS

Reference will now be made in detail to embodiments of the present invention, examples of which are illustrated in the accompanying drawings. Exemplary embodiments are described below to explain the present invention by referring to the figures and should not be considered limiting.

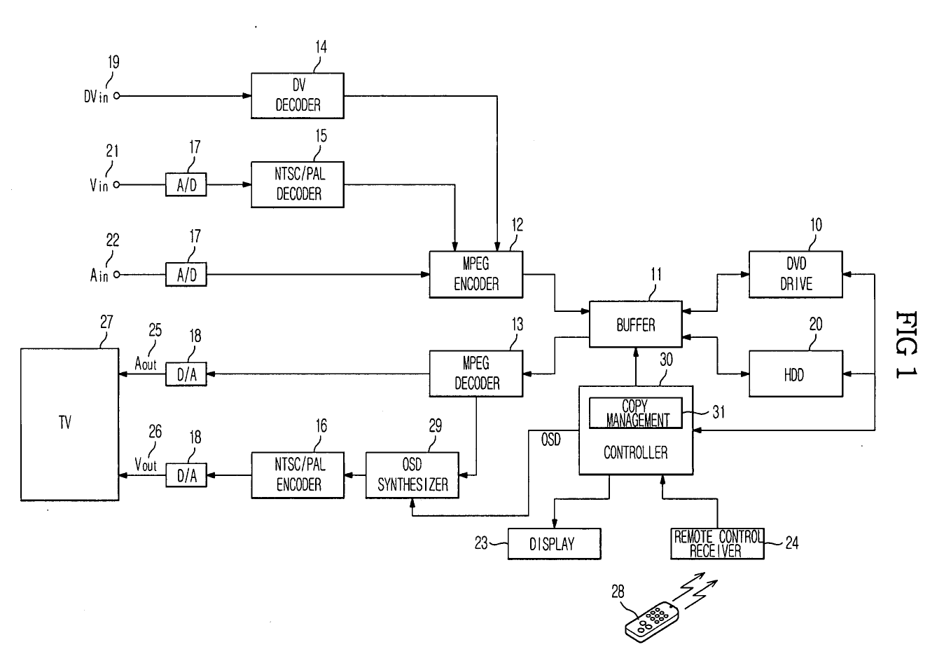

As shown in FIG. 1, an HDD/DVD recorder according to an embodiment of the present invention comprises a plurality of inputs 19, 21, and 22, outputs 25 and 26, a plurality of A/D converters 17 and D/A converters 18, a DV decoder 14, an NTSC/PAL decoder 15, and an NTSC/PAL encoder 16. The HDD/DVD recorder also comprises an MPEG encoder 12, an MPEG decoder 13, a controller 30, an On Screen Display (OSD) synthesizer 29, a buffer 11, a DVD drive 10, an HDD 20, a display 23, and a remote control receiver 24.

The inputs of the HDD/DVD recorder include a digital interface terminal (DVin) 19, a video input (Vin) 21, and an audio input (Ain) 22. In the embodiment of FIG. 1, AV data in digital video format is input to the digital interface terminal 19, video signals in NTSC or PAL format are input to the video input 21, and audio signals are input to the audio input 22.

The outputs of the HDD/DVD recorder include a video output (Vout) 26 and an audio output (Aout) 25. The video output 26 outputs video signals in NTSC or PAL format to a TV 27 connected to the video output 26, and the audio output 25 outputs audio signals to the TV 27 connected to the audio output 25. Although NTSC and PAL signal formats are illustrated in the exemplary embodiments of the present invention, other signal formats such as ATSC format can be processed in yet other embodiments of the present invention.

The DV decoder 14 converts AV data input to the digital interface terminal 19 into video and audio signals in International Telecommunication Union (ITU)-R BT format. The NTSC/PAL decoder 15 converts a video signal in NTSC or PAL format input to the video input 21 into a video signal in ITU-R BT format. The NTSC/PAL encoder 16 converts a video signal of ITU-R BT format output from the MPEG decoder 13 into a video signal in NTSC or PAL format.

The MPEG encoder 12 compresses and encodes a video signal in ITU-R BT format and a digitalized audio signal using the MPEG-2 standard to generate an AV data stream. Conversely, the MPEG decoder 13 converts an AV data stream into a video signal in ITU-R BT format.

The controller 30 includes a copy management unit 31 for managing copy operations and controls each element of the HDD/DVD recorder. The copy management unit 31 controls copy-related operations of the HDD/DVD recorder. For example, the copy management unit 31 generates an OSD image of a copy menu or the like, and supplies the OSD image to the OSD synthesizer 29 so that the OSD image is displayed on the TV 27.

The buffer 11 temporarily stores an AV data stream. The DVD drive 10 receives a DVD disc, and records or reproduces data on or from the DVD disc. The HDD 20 also stores data.

The remote control receiver 24 receives a signal transmitted from a remote controller 28 and transfers it to the controller 30. The remote controller 28 includes a copy button (not shown) for setting a copy mode, a pause button (not shown) for pausing copying, a scan button (not shown) for scanning total titles at high speed, an enter button (not shown), and a tab button (not shown) for moving between buttons displayed on the TV screen to activate each button. In yet other embodiments of the present invention, up, down, left, and right navigation buttons can be provided for moving between buttons displayed on the TV screen to activate each button.

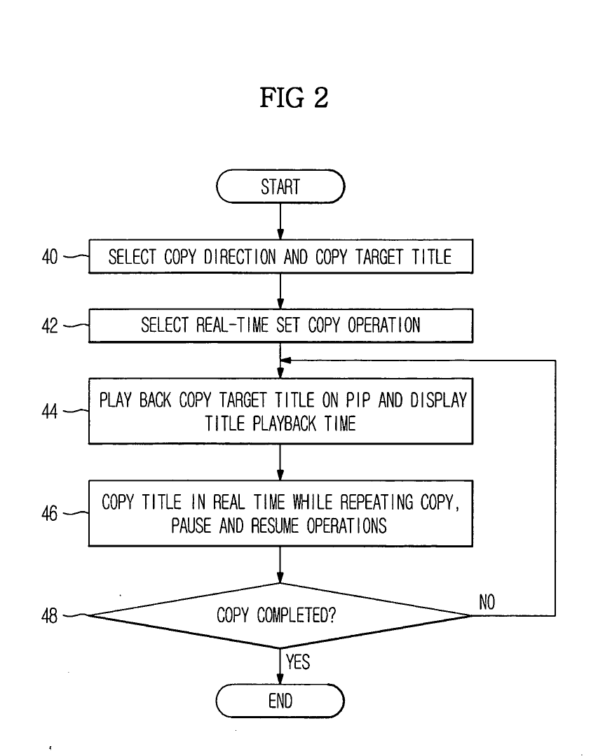

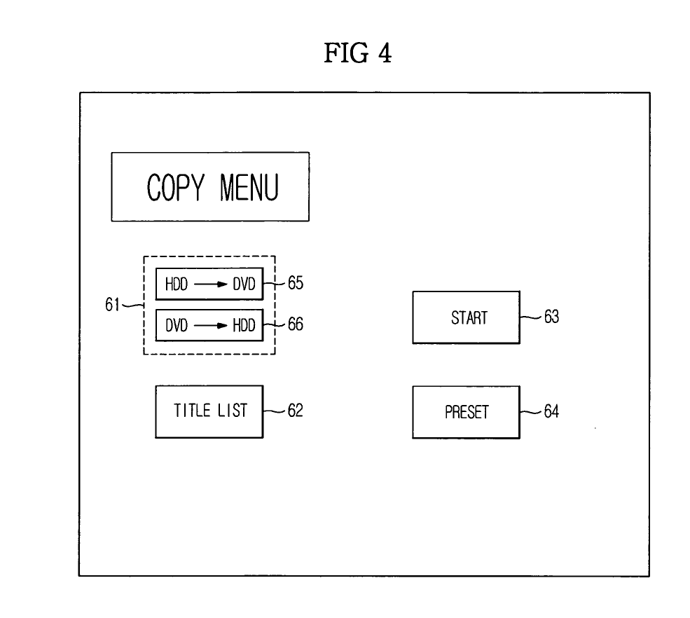

With reference to FIGS. 2, 4 and 5, a description will now be given of a method for performing a real-time set copy operation using the HDD/DVD recorder shown in FIG. 1. When the user desires to copy a title stored in the HDD 20 to a DVD disc, or desires to copy a title stored on a DVD disc to the HDD 20, the user first presses the copy button on the remote controller 28. The copy management unit 31 then allows a copy menu as shown in FIG. 4 to be displayed on the screen of the TV 27 connected to the HDD/DVD recorder.

The copy menu includes a copy direction selection portion 61 for determining whether copying is performed from the HDD 20 to a DVD disc or from a DVD disc to the HDD 20, a title list button 62 for displaying a total list of titles stored on a DVD disc inserted in the DVD drive 10 or stored in the HDD 20, a start button 63 for starting copying, and a preset button 64 for selecting a preset copy operation.

If the user selects a copy direction and presses the title list button 62 in the copy menu, a total list of titles stored in the HDD 20 or the DVD disc is displayed on the screen of the TV 27. When the total title list (not shown) is displayed on the screen of the TV 27, the user can select a title to be copied using the enter button. If the user selects a title, the copy management unit 31 changes the screen of the TV 27 back to the screen shown in FIG. 4 at step (40). After selecting the copy direction and the title to be copied, the user presses the start button 63 to start a real-time set copy operation at step (42).

In the exemplary embodiments of the present embodiment, the tab button on the remote controller 28 is used to activate the buttons, or icons, displayed on the TV screen. For example, when the copy menu is displayed on the TV screen, an HDD→DVD button 65 is initially activated, and a DVD→HDD button 66, the title list button 62, and the start button 63 are sequentially activated each time the tab button is pressed. If the enter button on the remote controller 28 is pressed with a button on the TV being activated, a command corresponding to the activated button is input to the controller 30.

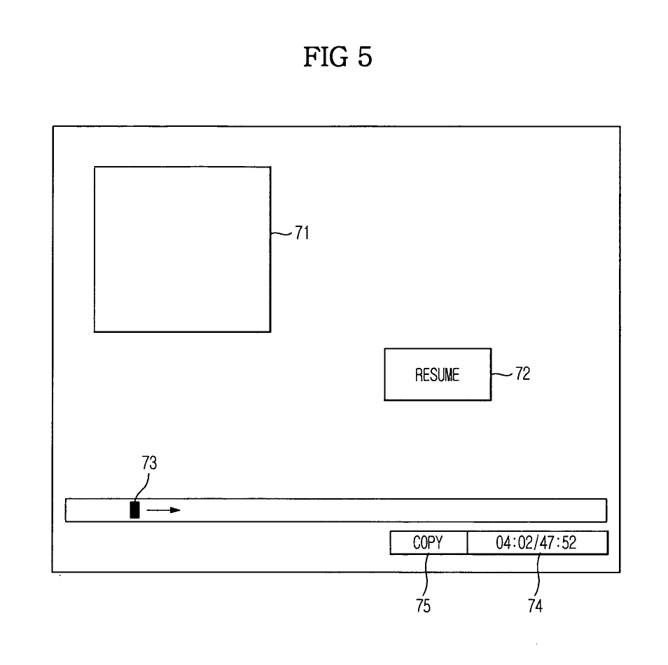

If the real-time set copy operation is initiated, the copy management unit 31 changes the screen of the TV 27 to a screen as shown in FIG. 5. The TV screen of FIG. 5 includes a Picture In Picture (PIP) 71 for playing back an original title selected by the user, a resume button 72 for resuming copying that has been suspended, a time bar 73, a playback time display portion 74 for displaying playback time of the title, and a copy state display portion 75 for displaying whether or not an image of the time displayed on the playback time display portion 74 is being copied.

The copy state display portion 75 displays “Copy” if an image of the time displayed on the playback time display portion 74 is being copied, and displays nothing if an image of the time displayed on the playback time display portion 74 is not being copied. In this manner, the copy state display portion 75 indicates whether or not an image currently displayed on the PIP 71 is being copied.

In the real-time set copy operation, the copy management unit 31 allows an original title to be copied to another storage medium while playing back the title on the PIP 71 at step (44). For example, if an original title is stored in the HDD 20, the copy management unit 31 allows the original title to be copied to a DVD disc loaded in the DVD drive 10. The copy management unit 31 continues the copying until the user presses the pause button on the remote controller 28 after the real-time set copy operation is initiated. If the user presses the pause button, the copy management unit 31 suspends the copying and still plays back the title on the PIP 71. Here, nothing is displayed on the copy state display portion 75.

While the copying is suspended, the user can replace the loaded DVD disc with another disc. When copying is performed from the HDD 20 to a DVD disc, the DVD disc can be replaced with another disc while the copying is suspended, so that images in the HDD 20 can be stored on different DVD discs. When copying is performed from a DVD disc to the HDD 20, the DVD disc can be replaced with another disc while the copying is suspended, so that images contained on different discs can be stored together in a single storage space.

Since the user views an image of the title which the user desires to copy, if the user presses the resume button 72 while watching the title played back on the PIP 71, the copy management unit 31 resumes copying and displays “Copy” on the copy state display portion 75. If the copying of the title is completed after repeating the copy, pause, and resume operations at step (46), the cycle is terminated at step (48).

Although embodiments of the present invention use the pause button provided on the remote controller 28 to pause copying in the real-time set copy operation, in other embodiments of the present invention, the pause button may be provided as an OSD item similar to the resume button 72 shown in FIG. 5.

Since the real-time set copy operation requires the user to set sections to be copied (that is, copy sections) and sections not to be copied (that is, non-copy sections) in real time, it is preferable that the real-time set copy operation be used for relatively low speed copying such as transrating copying, rather than high-speed copying.

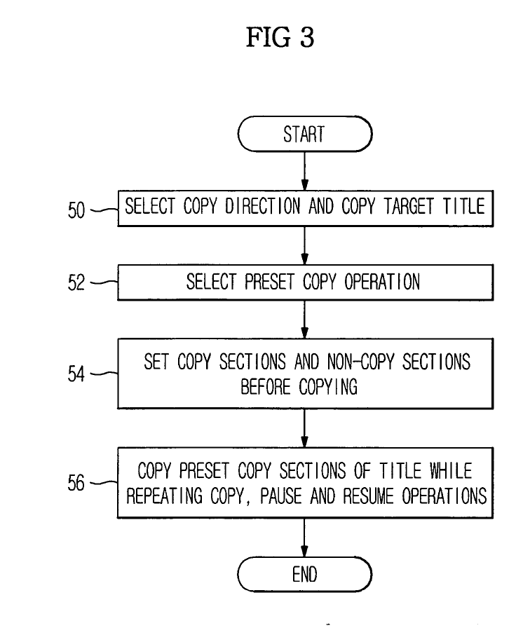

With reference to FIGS. 3, 4 and 6, a description will now be given of a method for performing a preset copy operation using the HDD/DVD recorder shown in FIG. 1. In the preset copy operation, a copy direction and a title to be copied are selected as in the real-time set copy operation at step (50). In this method, the HDD/DVD recorder operates in substantially the same manner as in the real-time set copy operation.

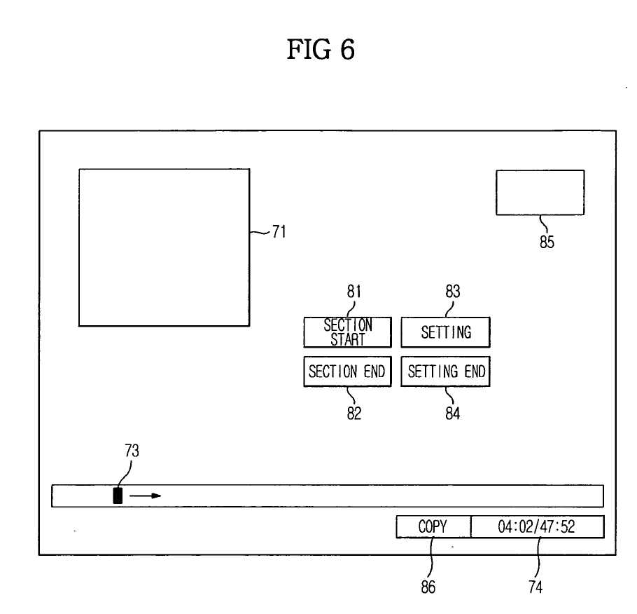

If the user presses the preset button 64 after selecting the copy direction and the copy target, the copy management unit 31 changes the screen of the TV 27 to a screen as shown in FIG. 6 at step (52). The screen of FIG. 6 includes section start and end buttons 81 and 82, respectively, for setting the start and end of a section to be copied, a setting button 83 and a setting end button 84 for starting and ending the copy section setting, a copy section count display window 85 for displaying the number of set copy sections, a PIP 71, a time bar 73, a playback time display portion 74, and a section state display portion 86.

The copy section count display window 85 displays the number of copy sections set by the user. If the number of copy sections exceeds a reference number, the copy section count display window 85 opens a warning window to inform the user. The section state display portion 86 displays “Copy” if the time displayed on the playback time display portion 74 corresponds to a copy section, and displays nothing if the time displayed on the playback time display portion 74 corresponds to a non-copy section. In this manner, the section state display portion 86 indicates whether an image currently displayed on the PIP 71 belongs to a copy section or a non-copy section. Through such a message of the playback time display portion 74, the user can confirm whether or not copy sections have been properly set.

If the user presses the setting button 83, the copy management unit 31 plays back the title on the PIP 71, and the user sets sections to be copied using the section start and end buttons 81 and 82 while viewing images of the title played back on the PIP 71 at step (54). Specifically, if the user presses the section start button 81, a copy section is started from that time, and if the user presses the section end button 82, the copy section is ended at that time. A number displayed on the copy section count display window 85 is incremented by one, each time a copy section is produced.

Once the user sets all copy sections and presses the setting end button 84, the copy management unit 31 changes the screen of the TV 27 back to the screen of FIG. 4. If the user presses the start button 63 in the screen of FIG. 4, the copy management unit 31 performs copying of the set copy sections. In the preset copy operation, the copy management unit 31 performs copying while repeating the copy, pause, and resume operations at step (56), even if the user does not press the pause button.

Although embodiments of the present invention have been described with reference to the copy menu items shown in FIG. 4, in yet other embodiments of the present invention, menu items other than those shown in FIG. 4 may be added to the copy menu as circumstances demand. For example, a transrating button for setting transrating copy may be added to the copy menu.

In addition, although embodiments of the present invention have been described with reference to the example in which the HDD/DVD recorder is used as a hybrid video device, in yet other embodiments, the present invention can also be applied to a video device such as a DVD recorder including two DVD drives or a DVD/VCR combo.

Further, although embodiments of the present invention have been described with reference to the copy operation that is divided into a real-time set copy operation and a preset copy operation, in yet other embodiments, the present invention may use a copy operation combining the real-time set copy operation and the preset copy operation. For example, the copy operation may be performed giving priority to the real-time set copy operation over the preset copy operation in such a manner that, even if copying of the preset copy operation is in progress after sections to be copied are previously set, the copying is paused if the user requests that the copying be paused.

As is apparent from the above description, embodiments of the present invention allow the user to selectively copy portions, desired by the user, of an original title, thereby improving user convenience.

In addition, when copying of a loaded DVD disc is suspended, the user can replace the loaded DVD disc with another disc. Thus, sections of video, which have been stored in an HDD, can be stored on different DVD discs. Also, video, which has been stored on different discs, can be stored together in a single storage space, thereby allowing the user to conveniently manage video.

Further, there is no need to produce a playlist to copy portions, desired by the user, of a title as in the conventional hybrid video device, thereby increasing convenience.

Although a number of exemplary embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A hybrid video device comprising:
a first video recording unit;
a second video recording unit for recording video independently of the first video recording unit; and
a copy management unit for performing copy management such that a part of an original title stored in one of the first and second video recording units can be selected by a user and can be copied to the other video recording unit.

2. The hybrid video device according to claim 1, wherein the first video recording unit is comprised of at least one Hard Disk Drive (HDD), and the second video recording unit is comprised of at least one Digital Versatile Disc (DVD) drive.

3. The hybrid video device according to claim 1, wherein the first and second video recording units are comprised of at least one Hard Disc Drive (HDD).

4. The hybrid video device according to claim 1, further comprising:
a display, configured to display a plurality of items of an On Screen Display (OSD) and which is connected to the hybrid video device to allow the user to easily select a part of the original title which the user desires to copy.

5. The hybrid video device according to claim 4, wherein the OSD is comprised of:
a start button for starting copying; and
a preset button for selecting a preset copy operation in which sections to be copied are previously set before copying is performed.

6. The hybrid video device according to claim 4, wherein the OSD is comprised of at least one of a pause button for pausing copying and a resume button for resuming copying in a real-time set copy operation in which a part of the original title to be copied is set in real time.

7. The hybrid video device according to claim 4, wherein the OSD is comprised of a section start button and a section end button for setting a section to be copied in a preset copy operation.

8. The hybrid video device according to claim 4 wherein the OSD is comprised of a copy section count display window for displaying a number of copy sections set in a preset copy operation.

9. A method for copying part of an original title in a hybrid video device, the hybrid video device comprising a first video recording unit and a second video recording unit for recording video independently of the first video recording unit, the method comprising the steps of:
copying an original title stored in one of the first and second recording units to the other recording unit while displaying the original title; and
pausing or resuming the copying in real time if a user requests that the copying be paused or resumed, respectively, before the copying is completed, thereby allowing a part of the original title desired by the user to be copied.

10. A method for copying part of an original title in a hybrid video device according to claim 9, further comprising the step of providing a copy menu display for selecting at least one of a copy direction, a title to be copied, and a real time copy operation start.

11. A method for copying part of an original title in a hybrid video device according to claim 10, further comprising the steps of:
providing a real time copy display when a real time copy operation is started, the real time copy display having a picture in picture display and a playback time display; and
pausing or resuming the copying in real time based upon at least one of the picture in picture display and the playback time display.

12. A method for copying part of an original title in a hybrid video device, the hybrid video device comprising a first video recording unit and a second video recording unit for recording video independently of the first video recording unit, the method comprising the steps of:
previously setting sections of an original title stored in one of the first and second recording units according to user selections and which are to be copied to the other recording unit; and
copying the previously set copy sections when copying of the original title is performed, thereby allowing a part of the original title desired by the user to be copied.

13. A method for copying part of an original title in a hybrid video device according to claim 12, further comprising the step of providing a copy menu display for selecting at least one of a copy direction, a title to be copied, and a preset copy operation start.

14. A method for copying part of an original title in a hybrid video device according to claim 13, further comprising the steps of:
providing a preset copy display when a preset copy operation is started, the preset copy display having a picture in picture display, a playback time display, and preset section start and end controls for defining set sections; and
copying previously set sections based upon the set sections.

15. The method according to claim 12, wherein the number of sections to be copied is limited to a reference number or fewer.
